(19) United States
(12) Patent Application Publication
(10) Pub. No.: US 2026/0021903 A1
(43) Pub. Date: Jan. 22, 2026

(54) AIRCRAFT SUITE SLIDING DOOR MALFUNCTION INDICATOR

(71) Applicant: B/E Aerospace, Inc., Winston-Salem, NC (US)

(72) Inventor: Michael E. Bormann, Kernersville, NC (US)

(21) Appl. No.: 18/779,657

(22) Filed: Jul. 22, 2024

(51) Int. Cl. B64D 45/00; B64D 11/06

(52) U.S. Cl. CPC B64D 45/0005; B64D 11/0606

(57) ABSTRACT

A malfunction indicator assembly for a suite door slidable along a redundant rail system. The malfunction indicator assembly includes a weighted malfunction indicator pivotally mountable to a stationary wall and carrying a first magnet, and a second magnet mountable to one end of a secondary rail and carriage subassembly proximal to the weighted malfunction indicator. In use, in the absence of primary rail and carriage subassembly failure, a magnetic connection is maintained between the first and second magnets such that the indicator does not present outside of a vertical plane of the stationary wall, and in the presence of the primary rail and carriage failure the magnetic connection is broken to present the indicator outside of the vertical plane of the stationary wall. In embodiments, upper and lower malfunction indicators operate independently to report failures.

### TECHNICAL FIELD AND BACKGROUND

The present disclosure relates generally to door assemblies for suites such as aircraft passenger suites, and more particularly, to a malfunction indicator for alerting the flight crew to an improperly functioning aircraft suite sliding door.

Aircraft premium and super first-class suites typically have doors to provide privacy for passengers. Traditional suite doors operate linearly on a package of linear rails and carriages. Aviation safety guidelines mandate the use of malfunction indicators to alert the flight crew to a situation where the rails are operating improperly. Traditional malfunction indicators are mechanical in nature and thus more susceptible to part failure, mechanical adjustment, and maintenance needs.

Accordingly, what is needed is an easily maintainable, automatic indicator for when one of the door rails fails, as well as an indicator that automatically resets once the error condition is rectified.

### BRIEF SUMMARY

According to one aspect, the inventive concepts according to the present disclosure are directed to a malfunction indicator assembly for a suite door slidable along a redundant rail system including a primary rail and carriage subassembly and a secondary rail and carriage subassembly. In embodiments, the malfunction indicator assembly includes a weighted malfunction indicator pivotally mountable to a stationary wall slidably supporting the suite door, the weighted malfunction indicator positionable at one end of the redundant rail system, and the weighted malfunction indicator carrying a first magnet, and a second magnet mountable to one end of the secondary rail and carriage subassembly proximal to the weighted malfunction indicator. In use, in the absence of primary rail and carriage subassembly failure, a magnetic connection is maintained between the first magnet and the second magnet such that the weighted malfunction indicator is maintained in a first position in which the weighted malfunction indicator does not present outside of a vertical plane of the stationary wall. In use, in the presence of primary rail and carriage subassembly failure, the magnetic connection between the first magnet and the second magnet is broken when the secondary rail and carriage subassembly moves apart from the weighted malfunction indicator such that the weighted malfunction indicator automatically pivots to a second position in which the weighted malfunction indicator presents outside of the vertical plane of the stationary wall.

In some embodiments, in use, when the failure of the primary rail and carriage subassembly is rectified and the secondary rail and carriage subassembly is again positioned proximal to the weighted malfunction indicator, the first magnet is drawn to the second magnet to return the weighted malfunction indicator to the first position.

In some embodiments, wherein the first magnet is positioned proximal to one end of the weighted malfunction indicator, and a portion of the weighted malfunction indicator presented outside the vertical plane of the stationary wall is positioned at an opposite end of the weighted malfunction indicator.

In some embodiments, the weighted malfunction indicator is brightly colored to draw attention to the weighted malfunction indicator presented outside of the vertical plane of the stationary wall.

In some embodiments, the weighted malfunction indicator is pivotally mounted to a mounting block mounted inside the stationary wall.

In some embodiments, the weighted malfunction indicator pivots between 5° and 45° between the first and second positions.

According to another aspect, the inventive concepts according to the present disclosure are directed to a door assembly including a stationary wall, a sliding door, and a redundant rail system slidably coupling the sliding door to the stationary wall, the redundant rail system including a primary rail and carriage subassembly, and a secondary rail and carriage subassembly, wherein the sliding door is configured to slide via the primary rail and carriage subassembly, and slide via the secondary rail and carriage subassembly in the event of primary rail and carriage subassembly failure. The door assembly further includes a malfunction indicator assembly including a weighted malfunction indicator pivotally mounted inside the stationary wall and positioned at one end of the redundant rail system, the weighted malfunction indicator carrying a first magnet, and a second magnet mountable to one end of the secondary rail and carriage subassembly proximal to the weighted malfunction indicator. In use, in the absence of primary rail and carriage subassembly failure, a magnetic connection is maintained between the first magnet and the second magnet such that the weighted malfunction indicator is maintained in a first position in which the weighted malfunction indicator does not present outside of a vertical plane of the stationary wall. In use, in the presence of primary rail and carriage subassembly failure, the magnetic connection between the first magnet and the second magnet is broken when the secondary rail and carriage subassembly moves apart from the weighted malfunction indicator such that the weighted malfunction indicator automatically pivots to a second position in which the weighted malfunction indicator presents outside of the vertical plane of the stationary wall.

In some embodiments, in use, when the failure of the primary rail and carriage subassembly is rectified and the secondary rail and carriage subassembly is again positioned proximal to the weighted malfunction indicator, the first magnet is drawn to the second magnet to return the weighted malfunction indicator to the first position.

In some embodiments, in use, in the absence of primary rail and carriage subassembly failure, the secondary carriage does not move relative to the weighted malfunction indicator.

In some embodiments, the redundant rail system is positioned at an upper end of the stationary wall and the door, the door assembly includes a further redundant rail system positioned at a lower end of the stationary wall and the door and a further malfunction indicator assembly associated with the further redundant rail system, and the malfunction indicator assembly and the further malfunction indicator assembly operate independently.

According to a further aspect, the inventive concepts according to the present disclosure are directed to a sliding door assembly for an aircraft passenger suite including the stationary wall, sliding, door, upper and lower redundant rails system, and upper and lower weighted malfunction indicators associated with the respective upper and lower redundant rail systems, wherein the upper and lower weighted malfunction indicators operate independently such that one indicator is not dependent on the other.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A is an isometric view of a sliding suite door assembly, in accordance with example embodiments of this disclosure;

FIG. 1B is a detailed view of FIG. 1A showing an upper malfunction indicator in a first position corresponding to the absence of upper rail failure;

FIG. 1C is a detailed view of FIG. 1A showing a lower malfunction indicator in a first position corresponding to the absence of lower rail failure;

FIG. 2A is an isometric view of the sliding suite door assembly, in accordance with example embodiments of this disclosure;

FIG. 2B is a detailed view of FIG. 2A showing the upper malfunction indicator in a second position corresponding to the presence of upper rail failure;

FIG. 2C is a detailed view of FIG. 2A showing the lower malfunction indicator in a second position corresponding to the presence of lower rail failure;

FIG. 3 is an end view of the door assembly showing the malfunction indicator in the first position corresponding to the absence of rail failure, in accordance with example embodiments of this disclosure;

FIG. 4 is an end view of the door assembly showing the malfunction indicator in the second position corresponding to the presence of rail failure, in accordance with example embodiments of this disclosure;

FIG. 5 is a fragmentary isometric view of the door assembly showing relative component positions, in accordance with example embodiments of this disclosure; and

FIG. 6 is a fragmentary isometric view of the door assembly showing secondary carriage motion away from the malfunction indicator thereby breaking the magnetic connection allowing the malfunction indicator to present, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a malfunction indicator system for indicating a failure associated with a sliding rail system. In an exemplary embodiment, the malfunction indicator system may be associated with a linear rail system for controlling linear motion of a sliding door. In a particular conceived example, the sliding door is a suite door associated with an aircraft passenger suite, wherein the sliding door is slidable along a redundant rail system including a primary rail/carriage subassembly and a secondary rail/carriage subassembly, and wherein the secondary rail/carriage subassembly operates to stow the door in the event the primary rail/carriage subassembly fails. In other words, the redundant rail system is provided such that the sliding door can be opened for passenger egress in the event the primary rail/carriage subassembly fails.

In use, in the presence of primary rail/carriage subassembly failure, as the sliding door travels via the secondary rail/carriage subassembly, a magnetic connection is broken thereby causing the malfunction indicator to deploy to a position in which the malfunction indicator is visibly presented to the flight crew. When the sliding door is returned to the deployed state, the malfunction indicator is configured to automatically reset. If the primary rail/carriage failure no longer exists, the sliding door will operate as intended via the primary rail/carriage and the malfunction indicator will not deploy to present to the flight crew. However, if the failure persists, the sliding door will again deploy along the secondary rail/carriage thereby deploying the malfunction indicator. In some embodiments, the sliding door is configured to slide via upper and lower like redundant rail systems and therefore includes upper and lower malfunction indicators that operate independently such that the upper malfunction indicator is not dependent on the lower malfunction indicator and vice versa.

In embodiments, the door assembly may include an emergency egress solution. In a particular conceived example, the passenger suite may include an aisle entrance for accessing an interior space, and the door assembly may be positioned alongside the aisle. In embodiments, the door assembly includes a stationary wall and a door movable relative to the stationary wall between a deployed position closing the entrance and stowed position opening the entrance. In some embodiments, the door translates horizontally between the stowed and deployed positions. The door assembly may be used in conjunction with other applications and interior spaces that benefit from such a solution.

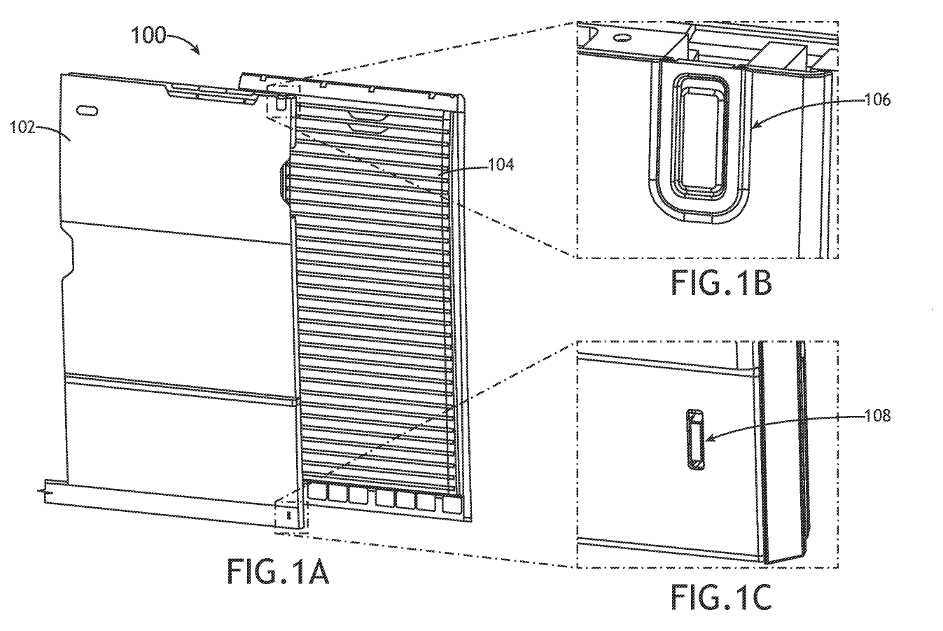

FIG. 1A illustrates a non-limiting example of a door assembly 100 for an aircraft passenger suite. The door assembly 100 generally includes a stationary wall 102 and a sliding door 104. The sliding door 104 may be slidably coupled to the stationary wall 102 such that the sliding door 104 slides along or from within the stationary wall 102. As used herein, the term “stationary” with regard to the stationary wall 102 means that the sliding door 104 moves relative to the stationary wall 102 and does not preclude the entire door assembly 100 from being movable within the aircraft. In some embodiments, the sliding door 104 translates horizontally between a stowed position opening the suite entrance and a deployed position closing the suite entrance. One skilled in the art of aircraft interiors will readily understand that the stationary wall 102 would form a portion of a suite wall, typically positioned alongside an aisle, and the sliding door 104 would open and close across the suite entrance.

As discussed in detail below, sliding door motion is controlled via an upper redundant rail system and a lower redundant rail system. In use, the upper redundant rail system slidably couples the upper end of the sliding door 104 to the stationary wall 102, and the lower redundant rail system slidably couples the lower end of the sliding door 104 to the stationary wall 102. The upper and lower redundant rail systems may be the same, substantially the same, or different. Each redundant rail system is associated with a malfunction indicator system, thus the door assembly 100 includes an upper malfunction indicator assembly 106 associated with the upper redundant rail system, and a lower malfunction indicator assembly 108 associated with the lower redundant rail system. The upper and lower malfunction indicator assemblies 106, 108 may be the same or substantially the same, and therefore may be referred to collectively herein as the malfunction indicator assembly 106. As shown, the upper malfunction indicator assembly 106 may have a different aesthetic appearance as compared to the lower malfunction indicator assembly 108, for example different trim elements, to match the aesthetics of the stationary wall 102.

FIG. 1B is a detailed view of FIG. 1A illustrating the upper malfunction indicator assembly 106 in a first position corresponding to a stowed state of the malfunction indicator corresponding to the absence of upper rail system failure. When in the first position, the malfunction indicator does not present outside of a vertical plane of the stationary wall 102 thus indicating to the flight or service crew that the upper redundant rail system is operating properly (i.e., absence of upper rail system failure). Likewise, FIG. 1C is a detailed view of FIG. 1A illustrating the lower malfunction indicator assembly 108 in a first position corresponding to a stowed state of the malfunction indicator corresponding to the absence of lower rail system failure. When in the first position, the malfunction indicator does not present outside of the vertical plane of the stationary wall 102 thus indicating to the flight or service crew that the lower redundant rail system is operating properly (i.e., absence of lower rail system failure).

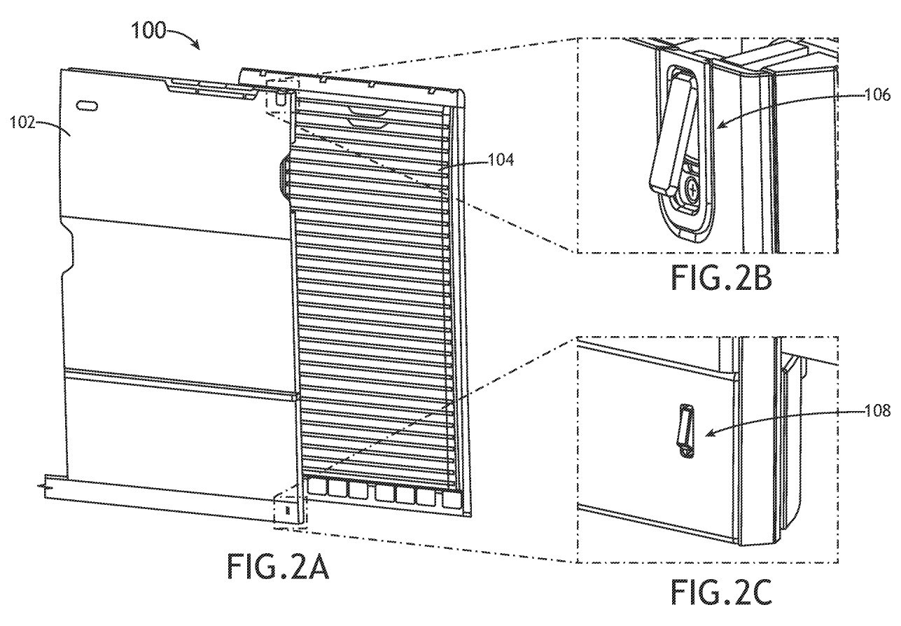

FIG. 2A illustrates the same door assembly 100 wherein the upper and lower rail assemblies are each reporting a failure in connection with their respective rail system. FIG. 2B is a detailed view of FIG. 2A illustrating the upper malfunction indicator assembly 106 in a second position corresponding to a deployed state of the malfunction indicator corresponding to presence of upper rail system failure. When in the second position, the malfunction indicator presents outside of the vertical plane of the stationary wall 102 thus indicating to the flight or service crew that the upper redundant rail system has failed or is otherwise malfunctioning. Likewise, FIG. 2C is a detailed view of FIG. 2A illustrating the lower malfunction indicator assembly 108 in a second position corresponding to a deployed state of the malfunction indicator corresponding to the presence of lower rail system failure. When in the second position, the malfunction indicator presents outside of the vertical plane of the stationary wall 102 thus indicating to the flight or service crew that the lower redundant rail system has failed or is otherwise malfunctioning.

In some embodiments, portions of the malfunction indicator 106 may be brightly colored (e.g., red, orange, yellow, etc.) to draw the attention of the flight or service crew. In an alternative embodiment, the malfunction indicator 106 may be further mechanically, electrically, and/or communicatively coupled to an audible alarm and/or crew control panel configured to report a failure condition.

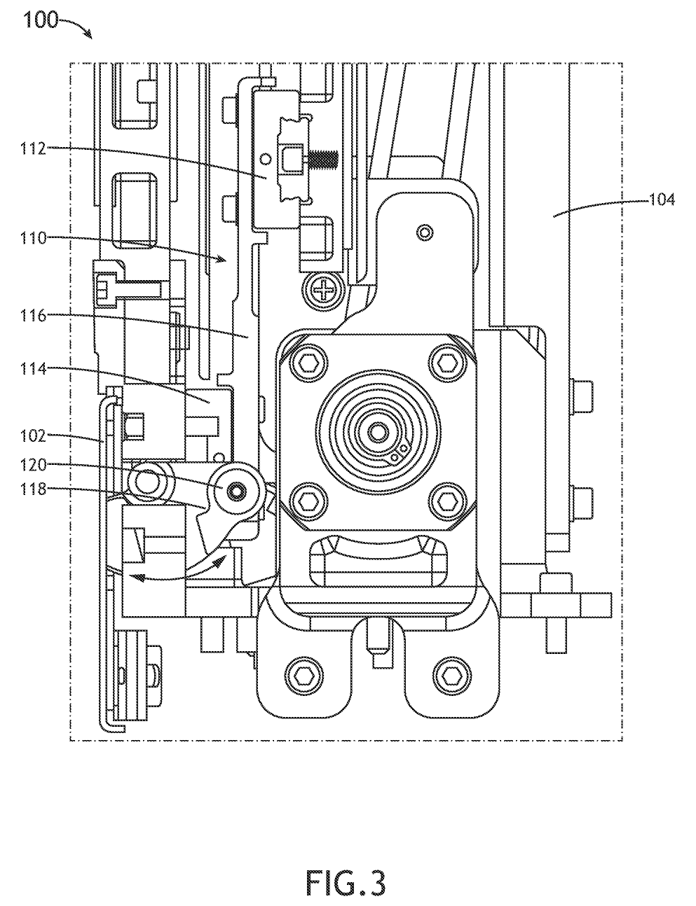

FIG. 3 illustrates elements of the door assembly 100 and malfunction indicator assembly when in the first position corresponding to the absence of rail system failure. Each redundant rail system 110 generally includes a primary rail and carriage subassembly 112, and a secondary rail and carriage subassembly 114. Each of the rails may be linear rails. During normal use, the primary rail and carriage subassembly 112 are operating properly to slide the door 104. In the event of primary rail and carriage subassembly 112 failure, the door stows via the secondary rail and carriage subassembly 114. In embodiments, the secondary rail and carriage subassembly 114 may further include or be attached to a carriage mounting block 116. The particulars and configurations of the primary and second rail and carriage subassemblies are not critical to the present invention and may vary so long as the second magnet is carried by a movable element movable apart from the first magnet to break the magnetic connection to indicate the malfunction.

The malfunction indicator assembly 106 includes a weighted malfunction indicator 118 pivotally mounted to the stationary wall 102 slidably supporting the suite door 102. As shown, the weighted malfunction indicator 118 is positioned at one end of the redundant rail system 110. The weighted malfunction indicator 118 carries at least one first magnet 120. In use as shown, in the absence of primary rail and carriage subassembly failure, a magnetic connection is maintained between the first magnet 120 and a second magnet (not shown) carried by the second rail and carriage subassembly such that the weighted malfunction indicator 118 is maintained in the first position in which the weighted malfunction indicator 118 does not present outside of the vertical plane of the stationary wall 102 (e.g., brightly colored portion is not visible and indicator flush with stationary wall 102).

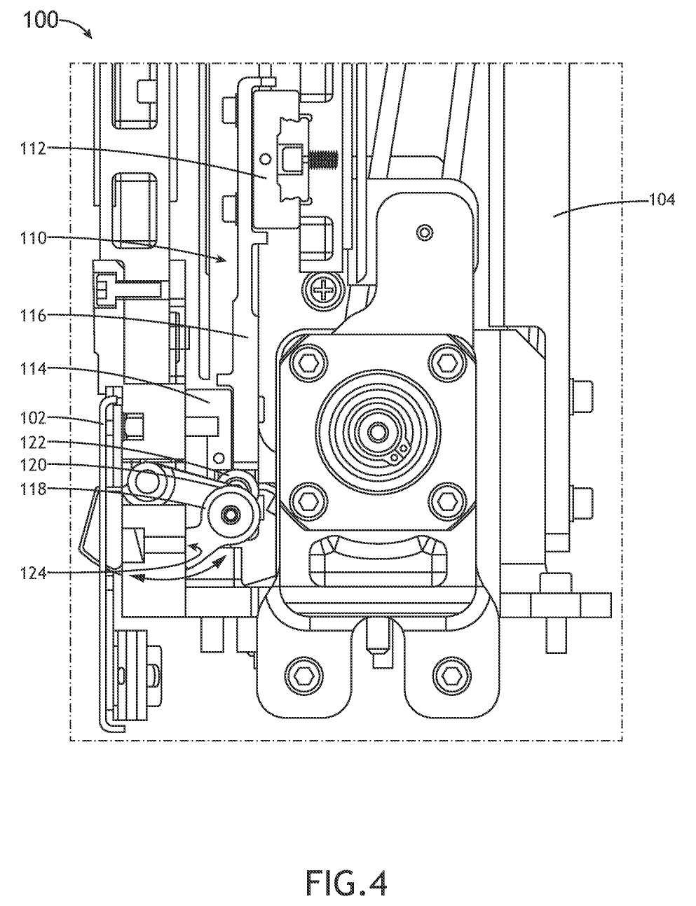

FIG. 4 illustrates the same door assembly 100 and malfunction indicator assembly, however, the malfunction indicator is shown when in the second position corresponding to the presence of the primary rail and carriage failure. To indicate a primary rail and carriage 112 failure, the weighted malfunction indicator 118 pivots (clockwise as shown in the drawing) to present a position of the weighted malfunction indicator 118 outside of the vertical plane of the stationary wall 102 (e.g., brightly colored portion is visible and portion of the indicator protrudes at an angle). In use as shown, in the presence of primary rail and carriage subassembly failure, the magnetic connection is broken between the first magnet 120 carried by the weighted malfunction indicator 118 and the second magnet 122 mounted to the secondary rail and carriage subassembly 114.

In embodiments, the weighted malfunction indicator 118 may pivot between about 5° and about 45° between the first and second positions, more preferably between about 5° and about 30°, and even more preferably between about 5° and about 15°. As shown, a stationary or adjustable hard stop 124 may be provided on the stationary wall 102 to limit ‘outward’ rotation of the weighted malfunction indicator 118, as well as to keep the first magnet 120 within magnetic range of the returning second magnet 122. In embodiments, the weighted malfunction indicator 118 is weighted, for instance counter-weighted, by the position of the first magnet 120 to cause the weighted malfunction indicator 118 to deploy automatically (e.g., pivot) when the magnetic connection is broken freeing the weighted malfunction indicator 118 to pivot freely. In embodiments, each of the first magnet 120 and the second magnet 122 may be neodymium magnets providing long magnetic life and strong draw.

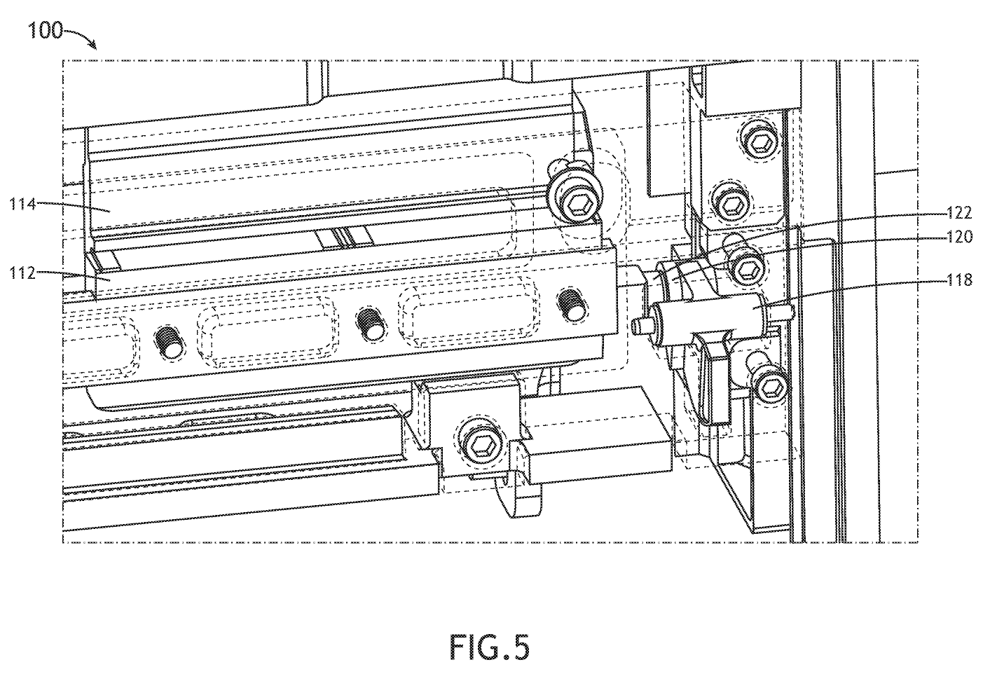

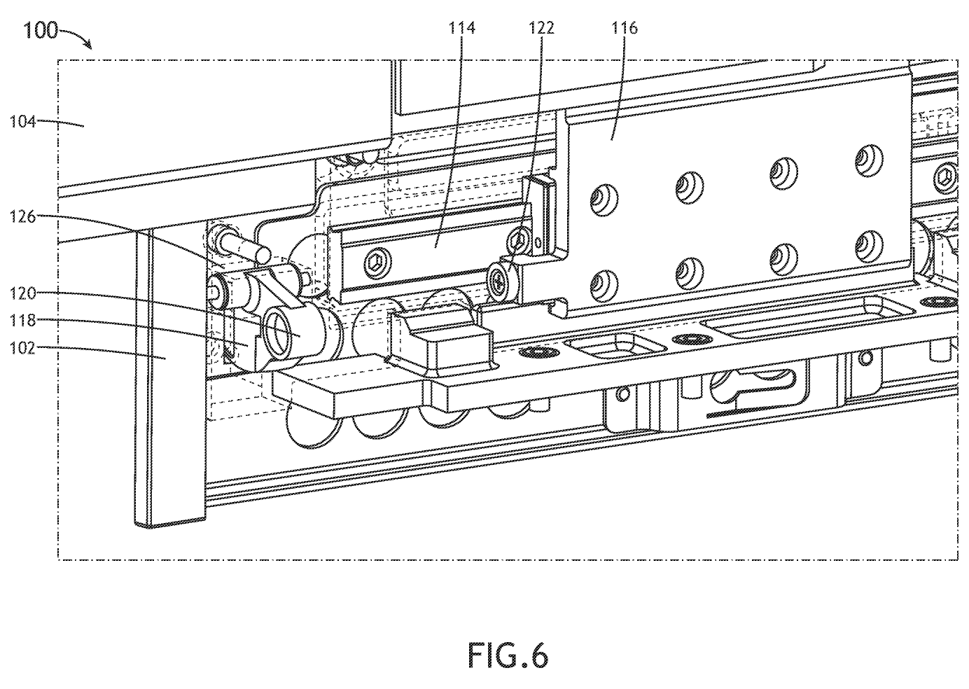

FIGS. 5 and 6 illustrate further details of the door assembly 100 and without showing the primary rail and carriage. The secondary rail and carriage subassembly, such as the carriage mounting block 116, carries the second magnet 122 for drawing the first magnet to position the weight malfunction indicator 118 in the first position as shown in FIG. 5. In embodiments, the weighted malfunction indicator 118 may include opposing pins pivotally mounted in a mounting block 126 (shown transparent). As shown, in FIG. 6, when the second rail and carriage subassembly 114 assumes responsibility for the door stowing motion, the motion of the secondary carriage and attached carriage mounting block 116 away from the weighted malfunction indicator 118 breaks the magnetic connection thereby freely the weight malfunction indicator 118 to pivot ‘outward’ to present the failure indication to the flight crew. FIG. 6 shows the magnetic connection broken but the weighted magnetic indicator 118 still in the first position.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A malfunction indicator assembly for a suite door slidable along a redundant rail system including a primary rail and carriage subassembly and a secondary rail and carriage subassembly, the malfunction indicator assembly comprising:
a weighted malfunction indicator pivotally mountable to a stationary wall slidably supporting the suite door, the weighted malfunction indicator positionable at one end of the redundant rail system, and the weighted malfunction indicator carrying a first magnet; and
a second magnet mountable to one end of the secondary secondary rail and carriage proximal to the weighted malfunction indicator;
wherein, in use:
in the absence of primary rail and carriage subassembly failure, a magnetic connection is maintained between the first magnet and the second magnet such that the weighted malfunction indicator is maintained in a first position in which the weighted malfunction indicator does not present outside of a vertical plane of the stationary wall; and
in the presence of primary rail and carriage subassembly failure, the magnetic connection between the first magnet and the second magnet is broken when the secondary carriage moves apart from the weighted malfunction indicator such that the weighted malfunction indicator automatically pivots to a second position in which the weighted malfunction indicator presents outside of the vertical plane of the stationary wall.

2. The malfunction indicator assembly according to claim 1, wherein, in use:
when the failure of the primary rail and carriage subassembly is rectified and the secondary rail and carriage subassembly is again positioned proximal to the weighted malfunction indicator, the first magnet is drawn to the second magnet to return the weighted malfunction indicator to the first position.

3. The malfunction indicator assembly according to claim 1, wherein the first magnet is positioned proximal to one end of the weighted malfunction indicator, and a portion of the weighted malfunction indicator presented outside the vertical plane of the stationary wall is positioned at an opposite end of the weighted malfunction indicator.

4. The malfunction indicator assembly according to claim 1, wherein the weighted malfunction indicator is brightly colored to draw attention to the weighted malfunction indicator presented outside of the vertical plane of the stationary wall.

5. The malfunction indicator assembly according to claim 1, wherein the weighted malfunction indicator is pivotally mounted to a mounting block mounted inside the stationary wall.

6. The malfunction indicator according to claim 1, wherein the weighted malfunction indicator pivots between 5° and 45° between the first and second positions.

7. A door assembly comprising:
a stationary wall;
a sliding door;
a redundant rail system slidably coupling the sliding door to the stationary wall, the redundant rail system including:
a primary rail and carriage subassembly; and
a secondary rail and carriage subassembly;
wherein the sliding door is configured to slide via the primary rail and carriage subassembly, and slide via the secondary rail and carriage subassembly in the event of primary rail and carriage subassembly failure; and
a malfunction indicator assembly including:
a weighted malfunction indicator pivotally mounted inside the stationary wall and positioned at one end of the redundant rail system, the weighted malfunction indicator carrying a first magnet; and
a second magnet mountable to one end of the secondary carriage proximal to the weighted malfunction indicator;
wherein, in use:
in the absence of primary rail and carriage subassembly failure, a magnetic connection is maintained between the first magnet and the second magnet such that the weighted malfunction indicator is maintained in a first position in which the weighted malfunction indicator does not present outside of a vertical plane of the stationary wall; and
in the presence of primary rail and carriage subassembly failure, the magnetic connection between the first magnet and the second magnet is broken when the secondary carriage moves apart from the weighted malfunction indicator such that the weighted malfunction indicator automatically pivots to a second position in which the weighted malfunction indicator presents outside of the vertical plane of the stationary wall.

8. The door assembly according to claim 7, wherein, in use:
when the failure of the primary rail and carriage subassembly is rectified and the secondary rail and carriage is again positioned proximal to the weighted malfunction indicator, the first magnet is drawn to the second magnet to return the weighted malfunction indicator to the first position.

9. The door assembly according to claim 7, wherein, in use:
in the absence of primary rail and carriage subassembly failure, the secondary rail and carriage subassembly does not move relative to the weighted malfunction indicator.

10. The door assembly according to claim 7, wherein:
the redundant rail system is positioned at an upper end of the stationary wall and the door; and
the door assembly comprises a further redundant rail system positioned at a lower end of the stationary wall and the door and a further malfunction indicator assembly associated with the further redundant rail system; and
the malfunction indicator assembly and the further malfunction indicator assembly operate independently.

11. The door assembly according to claim 7, wherein the first magnet is positioned proximal to one end of the weighted malfunction indicator, and a portion of the weighted malfunction indicator presented outside the vertical plane of the stationary wall is positioned at an opposite end of the weighted malfunction indicator.

12. The door assembly according to claim 7, wherein the weighted malfunction indicator is brightly colored to draw attention to the weighted malfunction indicator presented outside of the vertical plane of the stationary wall.

13. The door assembly according to claim 7, wherein the weighted malfunction indicator is pivotally mounted to a mounting block mounted inside the stationary wall.

14. The door assembly according to claim 7, wherein the weighted malfunction indicator pivots between 5° and 45° between the first and second positions.

15. A sliding door assembly for an aircraft passenger suite, comprising:
a stationary wall;
a sliding door;
a redundant rail system slidably coupling the sliding door to the stationary wall, the redundant rail system including:
a primary rail and carriage subassembly; and
a secondary rail and carriage subassembly;
wherein the sliding door is configured to slide via the primary rail and carriage subassembly, and slide via the secondary rail and carriage subassembly in the event of primary rail and carriage subassembly failure; and
a malfunction indicator assembly including:
a weighted malfunction indicator pivotally mounted inside the stationary wall and positioned at one end of the redundant rail system, the weighted malfunction indicator carrying a first magnet; and
a second magnet mountable to one end of the secondary rail and carriage subassembly proximal to the weighted malfunction indicator;
wherein, in use:
in the absence of primary rail and carriage subassembly failure, a magnetic connection is maintained between the first magnet and the second magnet such that the weighted malfunction indicator is maintained in a first position in which the weighted malfunction indicator does not present outside of a vertical plane of the stationary wall; and
in the presence of primary rail and carriage subassembly failure, the magnetic connection between the first magnet and the second magnet is broken when the secondary carriage moves apart from the weighted malfunction indicator such that the weighted malfunction indicator automatically pivots to a second position in which the weighted malfunction indicator presents outside of the vertical plane of the stationary wall.

16. The sliding door assembly according to claim 15, wherein, in use:
when the failure of the primary rail and carriage subassembly is rectified and the secondary rail and carriage subassembly is again positioned proximal to the weighted malfunction indicator, the first magnet is drawn to the second magnet to return the weighted malfunction indicator to the first position.

17. The sliding door assembly according to claim 15, wherein:
the redundant rail system is positioned at an upper end of the stationary wall and the door; and
the door assembly comprises a further redundant rail system positioned at a lower end of the stationary wall and the door and a further malfunction indicator assembly associated with the further redundant rail system; and
the malfunction indicator assembly and the further malfunction indicator assembly operate independently.

18. The sliding door assembly according to claim 17, wherein each of the weighted malfunction indicator and the further weighted malfunction indicator is brightly colored to draw attention to the weighted malfunction indicator and the further weighted malfunction indicator presented outside of the vertical plane of the stationary wall.

19. The sliding door assembly according to claim 17, wherein the weighted malfunction indicator is pivotally mounted to a first mounting block mounted inside the stationary wall, and the further counter-weight malfunction indicator is pivotally mounted to a second mounting block mounted inside the stationary wall.

20. The sliding door assembly according to claim 17, wherein each of the weighted malfunction indicator and the further weighted malfunction indicator are configured to pivot between 5° and 45° between the first and second positions.
